(19) United States
(12) Patent Application Publication
(10) Pub. No.: US 2010/0143777 A1
(43) Pub. Date: Jun. 10, 2010

(54) BATTERY COVER LATCH MECHANISM

(75) Inventors: YU ZHANG, Shenzhen City (CN); SHUI-JIN DONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/538,265

(22) Filed: Aug. 10, 2009

(30) Foreign Application Priority Data
Dec. 8, 2008 (CN) 200810306019.3

(51) Int. Cl. H01M 2/10

(52) U.S. Cl. 429/100

(57) ABSTRACT

A battery cover latch mechanism is provided including a housing, a battery cover and an elastic sheet. The battery cover includes a cover body. The battery cover has one end portion directly detachable locked to the housing. The cover body defines a cutout to form an elastic pressing portion of the cover body. The elastic sheet is secured to the housing, and the pressing portion is elastically latched to the elastic sheet.

### BACKGROUND

1. Technical Field

The present disclosure relates to battery cover latch mechanisms, and particularly to a battery cover latch mechanism used in portable electronic devices.

2. Description of Related Art

Portable electronic devices such as mobile phones and personal digital assistants (PDAs) are widely used. When a battery is installed in the portable electronic device, the battery is generally shielded and fixed in place by a battery cover mechanism.

A typical battery cover mechanism includes a cover and a housing. The cover includes a pin at on one end and a hook at an opposite end. The housing defines a receiving hole and a holding aperture. The hook can be inserted into the holding aperture, and the cover can be pressed towards the housing until the pin is received into the receiving hole. As such, the cover securely engages with the housing by the hooking of the hook. However, the pin tends to slide out of the receiving hole when subjected to a large external force.

Therefore, there is room for improvement within the art.

### BRIEF DESCRIPTION OF THE DRAWING

Many aspects of the new housing and method for fabricating the same can be better understood with reference to the following drawings. The components in the drawings are not necessarily drawn to scale, the emphasis instead being placed upon clearly illustrating the principles of the new housing and method for fabricating the same. Moreover, in the drawings, like reference numerals designate corresponding parts throughout the several views.

FIG. 1 is an exploded, isometric view of a battery cover latch mechanism according to an exemplary embodiment.

FIG. 2 is an enlarged view of a battery cover shown in FIG. 1.

FIG. 3 is an assembled view of the battery cover latch mechanism shown in FIG. 1.

FIG. 4 is a cross section of the battery cover latch mechanism in a locked status.

FIG. 5 is similar to FIG. 4, but in a released status.

### DETAILED DESCRIPTION

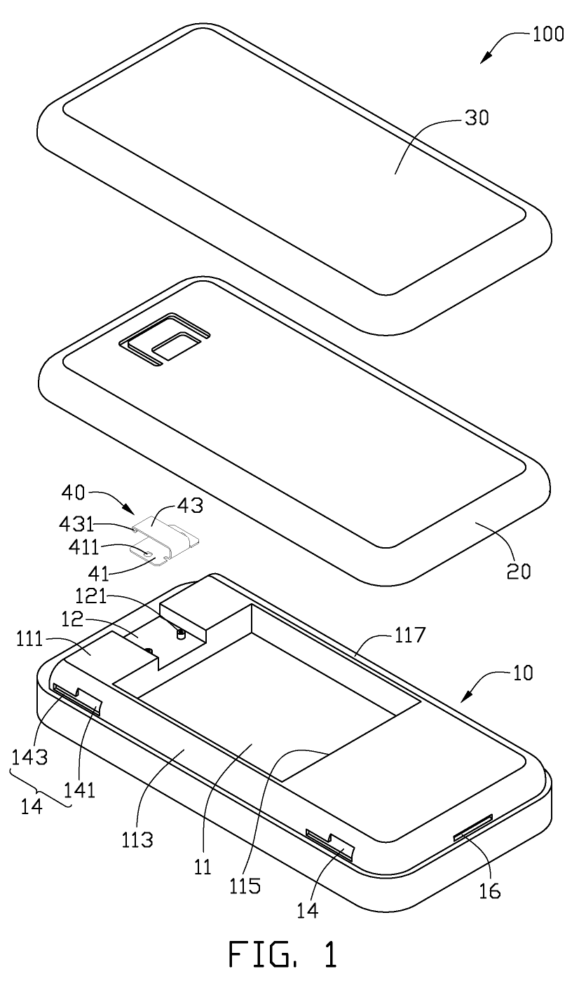

Referring to FIG. 1, an exemplary embodiment of a battery cover latch mechanism 100 for portable electronic devices includes a housing 10, a battery cover 20, a transparent protective foil 30, and an elastic sheet 40. The protective foil 30 securely envelops the exterior surface of the battery cover 20. The elastic sheet 40 can be secured to the housing 10.

The housing 10 contains electronic components such as the printed circuit board (not shown) therein. The housing 10 defines an battery accommodating space 11. The housing 10 includes a first end portion 111, a second end portion 113, a third end portion 115 and a fourth end portion 117. The first end portion 111, the second end portion 113, the third end portion 115 and the fourth end portion 117 connect with each other. The first end portion 111 defines a mounting groove 12 communicating with the battery accommodating space 11. The mounting groove 12 has two mounting columns 121 protruding from its bottom surface. The mounting columns 121 are used to mount the elastic sheet 40 thereon. Each of the third end portion 113 and the fourth end portion 117 defines two spaced L-shaped latching slots 14 at its external flange. Each latching slot 14 is exposed to the outside and includes a guiding slot section 141 and a sliding slot section 143. The guiding slot section 141 substantially perpendicularly communicates with the sliding slot section 143. The second end portion 115 defines an exposed notch 16 in its external flange.

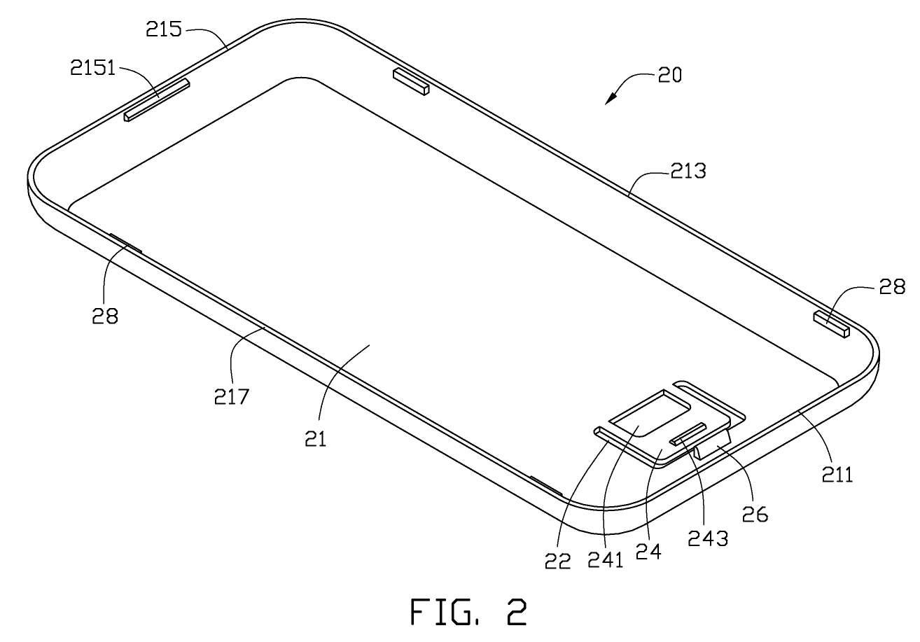

Referring to FIG. 2, the battery cover 20 includes a cover body 21 and a first sidewall 211, a second sidewall 213, a third sidewall 215 and a fourth sidewall 217. The first sidewall 211, the second sidewall 213, the third sidewall 215 and the fourth sidewall 217 connect with each other surrounding the cover body 21. A portion of the cover body 21 adjacent to the first sidewall 211 is cut to define a U-shaped cutout 22, and accordingly form a pressing portion 24 surrounded by the through cutout 22. The pressing portion 24 can be elastically bent upwardly. The pressing portion 24 has a protruding rib 243 formed towards the first sidewall 211. The pressing portion 24 defines a through hole 241. The through hole 241 facilities an easy bending of the pressing portion 24. A latching block 26 protrudes from the cover body 21 between the pressing portion 24 and the first sidewall 211.

Each of the second sidewall 213 and the fourth sidewall 217 has two latching portions 28 projecting towards the center of the battery cover 20 corresponding to the two latching slots 14. The third sidewall 215 has a locking portion 2151 projecting towards the center of the battery cover 20. The locking portion 2151 is used to be locked in the notch 16.

The elastic sheet 40 includes a sheet body 41 and an L-shaped resisting sheet portion 43. The resisting sheet portion 43 laterally extends from and located above the sheet body 41. The sheet body 41 defines two mounting holes 411 corresponding to the mounting columns 121. The mounting columns 121 can pass through and be secured into the mounting holes 411 to secure the elastic sheet 40 to the housing 10. The resisting sheet portion 43 has a curved resisting portion 431 formed at its distal end for resisting the latching block 26.

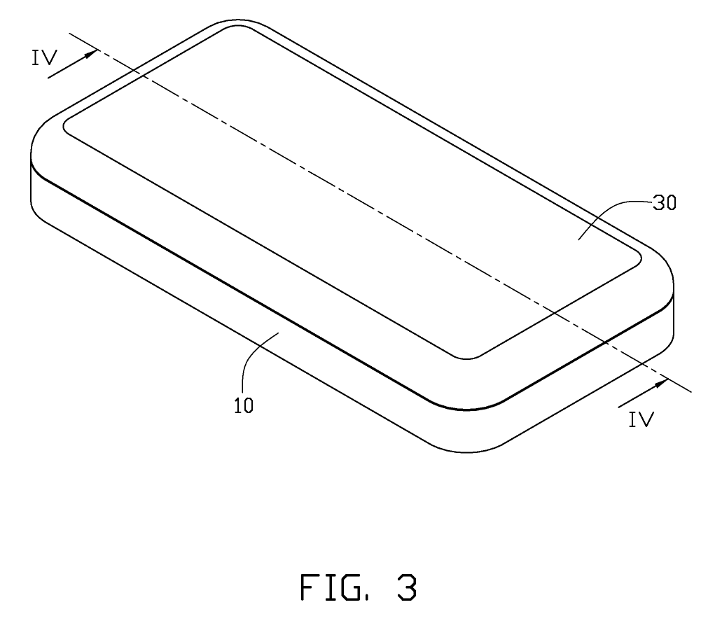

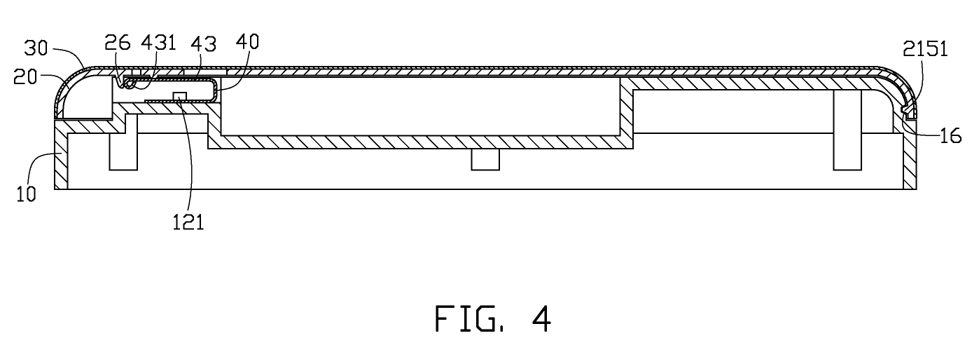

Referring further to FIGS. 3 and 4, after assembly, the elastic sheet 40 is secured in the mounting groove 12 by the securing of the mounting columns 121 into the mounting holes 411. Meanwhile, the extension of the resisting portion 431 is arranged away from the notch 16.

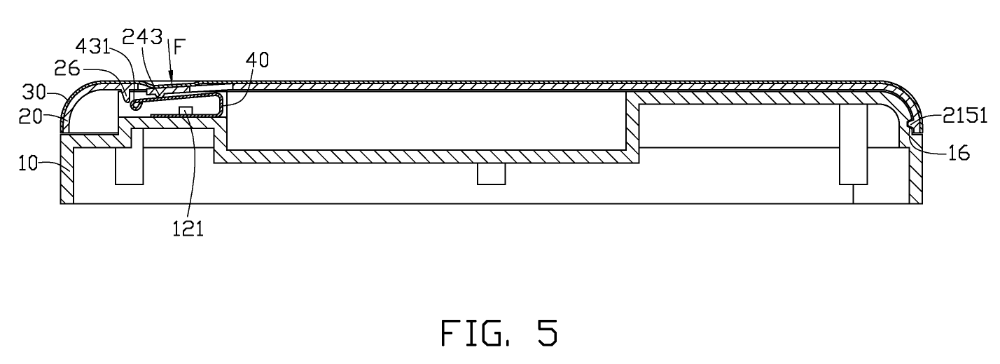

Referring again to FIG. 4, the battery cover 20 is latched to the housing 10. During this process, the battery cover 20 is pressed by an external force (illustrated by an arrow labeled with F shown in FIG. 5) towards to engage with the housing 10. The latching portions 28 are guided by the guiding slot sections 141 to slide into and along the sliding slot sections 143, respectively. The locking portion 2151 is locked into the notch 16. The resisting portion 431 is deformed to resist against the latching block 26. Due to the locking and resisting as above, the battery cover latch mechanism 100 can maintain its latched position.

Referring to FIG. 5, to release the latching of the battery cover 20, the pressing portion 24 aligned above the elastic sheet 40 is pressed to be bent downwardly towards the housing 10. Accordingly, the protruding rib 243 directly urges the elastic sheet 40 and the resisting portion 431 to move downwardly. The resisting portion 431 moves relative to the latching block 26 until the resisting of the resisting portion 431 and the latching block 26 is released. Once released, the battery cover 20 can be lifted to remove from the housing 10 in a reverse process relative to the pressing process.

It is to be understood that the protective foil 30 can be omitted. The protective foil 30 can be integrally formed on the battery cover 20, for example, by a dual injection molding.

It is to be understood, however, that even through numerous characteristics and advantages of exemplary embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A battery cover latch mechanism, comprising:
a housing;
a battery cover comprising a cover body, the battery cover having one end portion directly detachable locked to the housing, the cover body defining a cutout to form an elastic pressing portion of the cover body; and
an elastic sheet secured to the housing, the pressing portion elastically latched to the elastic sheet.

2. The battery cover latch mechanism as claimed in claim 1, wherein the elastic sheet comprises a sheet body, the sheet body defines a mounting hole, the housing comprises a mounting column, the mounting column passes through and secured in the mounting hole, securing the elastic sheet to the housing.

3. The battery cover latch mechanism as claimed in claim 2, wherein the elastic sheet further comprises a resisting sheet portion extending from the sheet body, the resisting sheet portion located above the sheet body.

4. The battery cover latch mechanism as claimed in claim 3, wherein the resisting sheet portion comprises a resisting portion, the cover body comprises a latching block, the latching block is configured to resist against the resisting portion.

5. The battery cover latch mechanism as claimed in claim 4, wherein the locking of the end portion of the battery cover to the housing and the resisting of the latching block against the resisting portion cooperatively latches the battery cover to the housing.

6. The battery cover latch mechanism as claimed in claim 3, wherein the pressing portion is configured to be elastically bent and defines a through hole.

7. The battery cover latch mechanism as claimed in claim 3, wherein the pressing portion comprises a protruding rib, the protruding rib configured to resist against the elastic sheet to release from the latching block during a bending of the pressing portion.

8. The battery cover latch mechanism as claimed in claim 1, wherein the battery cover latch mechanism further comprises a protective foil, the protective foil securely enveloping the exterior surface of the battery cover.

9. The battery cover latch mechanism as claimed in claim 8, wherein the protective foil, wherein the protective foil is adhered or integrally formed on the battery cover.

10. The battery cover latch mechanism as claimed in claim 1, wherein:
the housing comprises two latching slots at two opposite end portions, each of the two latching slots comprises a guiding slot section and a sliding slot section, the guiding slot section communicates with the sliding slot section; and
the battery cover comprises two latching portions, each of the two latching portions configured to be guided by the guiding slot section to slide into and along the sliding slot section.

11. A battery cover latch mechanism, comprising:
a housing;
a battery cover comprising a cover body, the battery cover having one end portion directly detachable locked to the housing;
an elastic sheet secured to the housing, the cover body comprising a bendable pressing portion above the elastic sheet, the pressing portion deformably latched to the elastic sheet, and the pressing portion configured to be bent to resist against the elastic sheet to release from the pressing portion.

12. The battery cover latch mechanism as claimed in claim 11, wherein the elastic sheet comprises a sheet body, the sheet body defines a mounting hole, the housing comprises a mounting column, the mounting column passes through and secured in the mounting hole, securing the elastic sheet to the housing.

13. The battery cover latch mechanism as claimed in claim 12, wherein the elastic sheet further comprises a resisting sheet portion extending from the sheet body, the resisting sheet portion located above the sheet body.

14. The battery cover latch mechanism as claimed in claim 13, wherein the resisting sheet portion comprises a resisting portion, the cover body comprises a latching block, the latching block is configured to resist against the resisting portion.

15. The battery cover latch mechanism as claimed in claim 14, wherein the locking of the end portion of the battery cover to the housing and the resisting of the latching block against the resisting portion cooperatively latches the battery cover to the housing.

16. The battery cover latch mechanism as claimed in claim 13, wherein the pressing portion is configured to be elastically bent and defines a through hole.

17. The battery cover latch mechanism as claimed in claim 13, wherein the pressing portion comprises a protruding rib, the protruding rib configured to resist against the elastic sheet to release from the latching block during a bending of the pressing portion.

18. The battery cover latch mechanism as claimed in claim 11, wherein the battery cover latch mechanism further comprises a protective foil, the protective foil securely enveloping the exterior surface of the battery cover.

19. The battery cover latch mechanism as claimed in claim 18, wherein the protective foil, wherein the protective foil is adhered or integrally formed on the battery cover.

20. The battery cover latch mechanism as claimed in claim 11, wherein:
the housing comprises two latching slots at two opposite end portions, each of the two latching slots comprises a guiding slot section and a sliding slot section, the guiding slot section communicates with the sliding slot section; and
the battery cover comprises two latching portions, each of the two latching portions configured to be guided by the guiding slot section to slide into and along the sliding slot section.
